(19) United States
(12) Patent Application Publication
(10) Pub. No.: US 2024/0028022 A1
(43) Pub. Date: Jan. 25, 2024

(54) PROGNOSIS OF HIGH VOLTAGE EQUIPMENT

(71) Applicant: HITACHI ENERGY SWITZERLAND AG, Baden (CH)

(72) Inventor: Yash Thaker, Raleigh, NC (US)

(21) Appl. No.: 18/039,750

(22) PCT Filed: Dec. 10, 2020
(86) PCT No.: PCT/EP2020/085595

§ 371 Date: Jun. 1, 2023

Related U.S. Application Data
(60) Provisional application No. 63/120,320, filed on Dec. 2, 2020.

(51) Int. Cl. G05B 23/02; G05B 17/02

(52) U.S. Cl. CPC G05B 23/024; G05B 23/0283; G05B 23/0245; G05B 17/02

(57) ABSTRACT

Various aspects of prognosis of an installed high voltage equipment (HVE) by a monitoring system are described. One or more models are dynamically selected from a plurality of models tuned from data obtained from a plurality of HVEs communicatively connected with the monitoring system. A failure mode of the installed HVE is predicted, based on input parameters associated with the installed HVE, using the one or more models. At least one prognostic response is determined for the installed HVE, based on the predicted failure mode, using the one or more models. The at least one prognostic response is provided for the installed HVE.

### CROSS REFERENCE TO RELATED APPLICATIONS

This application is a 35 U.S.C. § 371 national stage application of PCT International Application No. PCT/EP2020/085595 filed on Dec. 10, 2020, which in turn claims priority to U.S. Provisional Patent Application No. 63/120,320, filed on Dec. 2, 2020, the disclosures and content of which are incorporated by reference herein in their entirety.

### TECHNICAL FIELD

The present application relates in general to prognosis of electrical equipment and in particular to prognosis of high voltage equipment.

### BACKGROUND

High voltage equipment (HVE), such as power transformers, distribution transformers and substation electrical equipment, are used widely in a number of industries under different operating conditions. Monitoring and assessment of various online and offline performance data of the high voltage equipment is done for various purposes including fault detection, diagnosis, and prognosis so that appropriate actions may be undertaken to increase their service life and improve their availability and performance.

### SUMMARY

In one aspect, an example method for prognosis of an installed high voltage equipment (HVE) by a monitoring system is described. The method includes dynamically selecting one or more models from a plurality of models tuned from data obtained from a plurality of HVEs communicatively connected with the monitoring system. Further, a failure mode of the installed HVE is predicted based on measured and processed parameters (input parameters to a monitoring system) associated with the installed HVE using one or more models. At least one prognostic response is determined for the installed HVE based on the predicted failure mode using the one or more models and provided for the installed HVE.

In another aspect, a monitoring system for prognosis of an HVE is described. The system comprises a processor configured to execute instructions to: dynamically select one or more models from a plurality of models tuned from data obtained from a plurality of HVEs that are communicatively connected with the monitoring system; predict a failure mode of the installed HVE based on input parameters associated with the installed HVE using the one or more models; determine at least one prognostic response for the installed HVE based on the predicted failure mode using the one or more models; and provide the at least one prognostic response for the installed HVE.

In yet another aspect, a non-transitory computer-readable medium comprising instructions that, when executed by a processor, cause the processor to perform the methods of the present subject matter is described.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components where possible.

FIG. 1a illustrates an example network environment including a monitoring system for prognosis of installed HVE(s), in accordance with an example implementation of the present subject matter.

FIG. 1b illustrates an example monitoring system in which prognosis of an installed HVE may be performed based on data received from databases, in accordance with an example implementation of the present subject matter.

FIG. 2 is a schematic illustration of prognosis of an installed HVE performed by the system, in accordance with an example implementation of the present subject matter.

FIG. 3 is a schematic illustration of an example use case for dynamic selection of one or more models, in accordance with an example implementation of the present subject matter.

FIG. 4 illustrates an example method for prognosis of an installed HVE by a monitoring system, in accordance with an example implementation of the present subject matter.

### DETAILED DESCRIPTION

Electric power distribution and transmission systems are used widely by electric utility companies, power generation companies and various industries, including oil and gas, transportation, manufacturing, utilities, and the like, across different geographic locations. These systems include high voltage equipment (HVE), such as transformers, which are deployed under various operating and environmental conditions. The HVEs are typically expected to operate for a number of years. To further ensure increased lifetime, performance, and availability of the HVE, various parameters of the HVEs are monitored online or gathered through offline methods and assessed so that timely maintenance and other intervention as required may be performed.

The assessment of the various online and offline parameters helps in prediction of possible failures relating to HVEs. An HVE may encounter various types of failures, such as insulation failure relating to windings or bushings, the winding insulation failure can be disk to disk failure, transformer winding turn-to-turn failure, winding shielding and cabling failure, etc. and may be caused due to partial discharges, switching surges, impulse overvoltage, etc. The failures may be due to internal reasons, i.e., caused by a phenomenon occurring in the transformer, or external reasons, i.e., caused by a phenomenon occurring outside the transformer. The behavior of an HVE and onset of a failure can be analyzed from the online or/and offline data collected from the transformer which also includes tests conducted on the transformer after manufacturing at factory location and before installing the transformer at a site.

Several tests such as routine tests, type tests and special tests for specific purposes are conducted as part of quality and regulatory requirements. The data obtained from these tests are also useful to identify behavior of the HVE relating to induced/manufactured conditions/stresses and can be associated with specific design related aspects of the HVE. Also, the behavior can be captured with a model and can be used later on to analyze condition or health of the HVE and predict failure of the HVE based on these tests and periodic/continuous monitoring of the HVE.

There may be many different models existing from general studies of insulation, for example, Arrhenius model for ageing due to thermal stresses, power law model for ageing due to electrical stresses, etc., and other models created by correlating one or more parameters with age or conditions observed in the HVE. These models may be based on different principles/algorithms/techniques (for example, empirical models, stochastic models, neural network, machine learning etc.), events, failure causes and other complexities (such as combinations of stresses or events/phenomena relating to cause of failure or observed effect), thus creating scenarios where one model may be performing better than the others. For example, there can be a model better suited for failure caused by partial discharges and another model suitable for failure caused by overvoltage conditions or increased temperature. Similarly, there can be a model more suitable for bushing failures and another model for cooling system failure or failure in the windings. Further, models may have different accuracies in different scenarios, and may take different time and resources for computation. As the specifications, geographic locations, industries in which deployed, and operating conditions of the HVEs may vary widely, the aggregation and analysis of the data to obtain useful prognosis information can be challenging.

The present subject matter provides for prognosis of HVE using a monitoring system that is deployed for monitoring a plurality of HVEs. In one example, a plurality of models used for analysis including prognosis and failure prediction are adapted (tuned) to accurately correlate key/measured parameters/indicators with failure phenomena/health conditions, i.e., build better relationship between parameters associated with a cause and effect data obtained from a plurality of HVEs. As previously mentioned, the plurality of HVEs may correspond to HVEs deployed in different industries, geographical locations, under various operating conditions, and having different specifications. The models may correspond to stochastic models, machine learning models, empirical models, or the like, and may be generated based on historical data of the plurality of HVEs. The plurality of models may also be tuned based on the industry, availability of data, quality of data and specifications of the HVE. For example, a first model may be tuned for HVEs of a first specification deployed in a first industry, such as metro rail transport, while a second model may be tuned for HVEs of a second specification deployed in a second industry, such as oil and gas.

As there may be several different models that can represent a transformer component or a failure condition using different techniques, and thereby provide different outputs, the models may have different input data requirement (type of parameters/indicators used and size of data required for determining the model output), model training requirements, resource requirement, (such as processor and memory requirements), etc., the performance of the different models may vary based on such differences. The performance of the models may be monitored with help of various performance metrics for the plurality of the models and can be used as performance criteria for evaluation of models and selection of suitable model for analysis. The performance criteria for example can include accuracy/fidelity of the model to predict failure and recommend prognostic response. Other performance criteria include complexity of the model, which may affect time taken for computation and resource requirement, accuracy of time or cost estimation for the recommended prognostic response, how many and how much of data i.e. size (present and past data) and type (temperature, voltage, current etc.) of input data used, and the like. The plurality of models may also be updated (finetuned) based on feedback including actual action taken, improvement seen from online measurement or recent history after the prognostic response is performed, and the like. Over time, one or more models may evolve for its use as preferred models for observation/diagnosis/prognosis. Further, for prognosis of a particular installed HVE, one or more models may be dynamically selected from the plurality of models. The dynamic selection of the one or more models may be based on a periodic/continuous evaluation of the plurality of the models with one or more performance criteria for evaluation.

In one example, for prognosis, initially, a failure mode of the installed HVE may be predicted based on input parameters associated with the installed HVE using the one or more models. At least one prognostic response may be determined for the installed HVE based on the predicted failure mode using the one or more models. For example, the prognostic response may include a schedule for maintenance or servicing of the installed HVE to increase its lifetime and availability. The at least one prognostic response may be provided for the installed HVE. For example, the at least one prognostic response may be provided to an operator or a third party for undertaking appropriate action.

Thus, the present subject matter allows for reliable aggregation and analysis of HVE performance data and improved prognosis. It also reduces unexpected downtime of HVEs by leveraging historical performance data from HVEs deployed in similar conditions to tune (adapt or continue to develop) the models. It is also computationally efficient and reduces analysis and response time as it considers various performance criteria for selection of the models for performing prognosis.

The present subject matter is further described with reference to appended figures. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

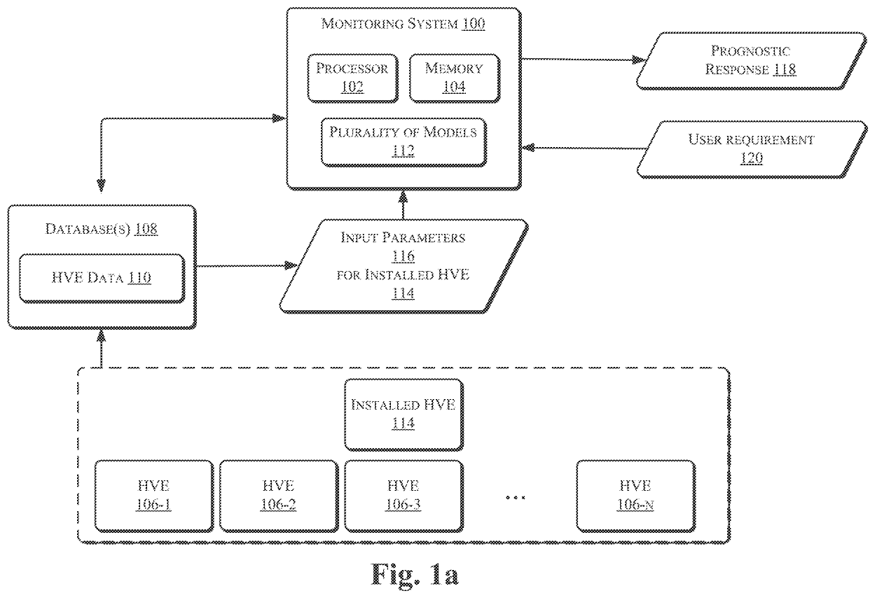

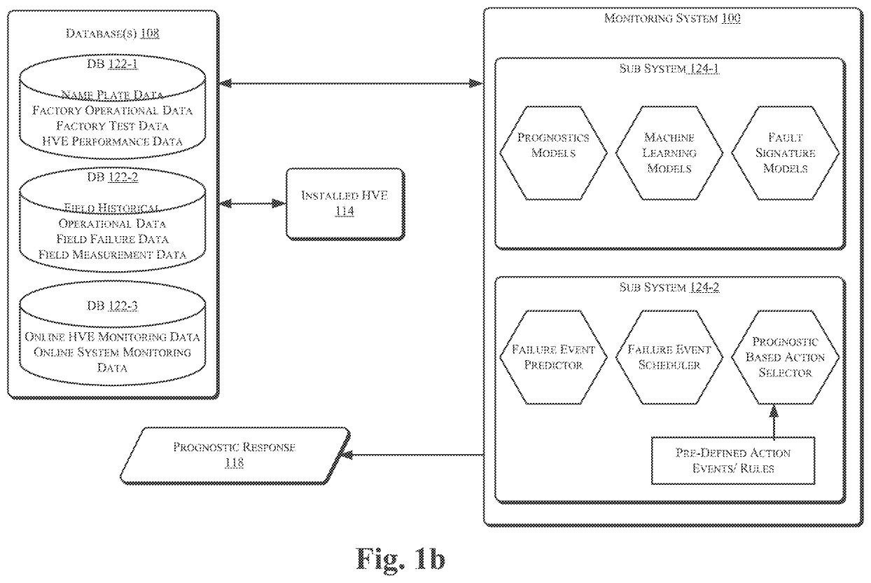

FIG. 1a illustrates an example network environment including a monitoring system 100 for prognosis of an installed HVE(s), in accordance with an example implementation of the present subject matter. The monitoring system 100, also referred to as system 100, may be implemented with an individual computing device, such as a desktop computer, a laptop computer, or a server or with a digital platform using a cloud system.

The system 100 includes a processor 102 and a memory 104 coupled to the processor 102. The processor 102 may be implemented as a microprocessor, a microcomputer, a microcontroller, a digital signal processor, a central processing unit, a state machine, a logic circuitry, a cloud system, and/or any device that can manipulate signals based on operational instructions. Among other capabilities, the processor 102 may fetch and execute computer-readable instructions included in the memory 104. Accordingly, steps described as being performed by the system 100 may be understood to be performed by the processor 102. The functions of the processor 102 may be provided through the use of dedicated hardware as well as hardware capable of executing machine-readable instructions.

The memory 104 may include any non-transitory computer-readable medium including volatile memory (e.g., RAM), and/or non-volatile memory (e.g., EPROM, flash memory, Memristor, etc.). The memory 104 may also be an external memory unit, such as a flash drive, a compact disk drive, an external hard disk drive, a database (server and/or cloud based), or the like. The memory 104 may include instructions that may be fetched and executed by the processor 102 to perform prognosis of an HVE.

In addition to the processor 102 and the memory 104, the system 100 may also include interface(s) and system data (not shown in FIG. 1a). The interface(s) may include a variety of instructions-based interfaces and hardware interfaces that allow interaction with a user and with other communication and computing devices, such as network entities, web servers, external repositories, and peripheral devices. The system data may serve as a repository for storing data that may be fetched, processed, received, or created by the instructions executed by the processor 102.

The system 100 may be communicatively connected to a plurality of HVEs 106-1, 106-2, 106-3 . . . 106-n, collectively referred to as a plurality of HVEs 106 to receive measured parameters (online/offline) as part of continuous/periodic monitoring of the HVEs, and one or more databases 108 that store information relating to the HVEs. Each HVE may be, for example, a transformer or other high voltage equipment used in electric power distribution and transmission. The plurality of HVEs 106 may include HVEs of different specifications, deployed in different geographical locations, and operated in different industries under different operating conditions. In one example, the system 100 may communicate with control/sensor devices associated with each of the plurality of HVEs 106 and the databases 108 over one or more communication networks (not shown in the figure), which may be a wireless or a wired network, or a combination thereof. A communication network may be a collection of individual networks, interconnected with each other and functioning as a single large network (e.g., the internet or an intranet). Depending on the underlying technology, the communication network may include various network entities, such as transceivers, gateways, servers, and routers.

Various online and offline data related to the plurality of HVEs 106 may be monitored and stored in the databases 108 as HVE data 110. The HVE data 110 thus aggregates and stores data related to the plurality of HVEs 106. The HVE data 110 may include various categories of data, such as manufactured or factory test data points, historical failure data points, offline information on operational data, system online monitoring data, and the like. While the following description is provided using transformer as an example HVE (installed HVE), it will be understood that the teachings of the present subject matter can be applied to other HVEs as well.

In one example, manufacture data of transformers may include parameters like name plate data of the transformers, details regarding routine tests, type tests and special tests performed on the transformers. In one example, name plate data of transformers may include details such as kVA rating of the transformers, the voltage ratio, the class of insulation used, presence of an online tap changer (OLTC), Basic Insulation Level (BIL) of the transformer and the like. Further, the type of routine tests may include no load loss test, magnetic current measurement, load loss measurement, voltage ratio, winding resistance, insulation dissipation factors, insulation resistance test, power factor test and the like. A few examples of the special tests that may be performed on the transformers include Dissolved Gas Analysis (DGA), sound level tests, zero-sequence impedance, partial discharge test and the like. The type tests particulars may include amongst other examples, temperature rise test, short circuit test and lightening impulse test.

In one example, the HVE data 110 stored in databases 108 may be used to set up benchmark values for a particular range of transformers or for transformers with particular specifications. In one example, all the tests performed measure specific transformer parameters which may be used to define relative type of problems associated with these parameters and for such determination, the values obtained or adapted from the initial tests are used as a benchmark (thresholds). For example, the DGA test would help define the problems such as temperature hot spots, general over-heating, chemical reactions, partial discharges, flashovers and the like. In another example, a temperature rise test would help define problems such as internal oil flow partially or fully blocked where the oil flow may be blocked by wrong arrangement of yoke collars and oil guiding rings. The parameters from the initial tests and those observed during continuous/periodic monitoring/testing can be used for benchmarks to determine health/conditions of the HVE.

Further, the HVE data 110 includes historical operational and failure data points of transformers, such as field historical operational data, field failure data, field measurement data, and the like. In one example, operational data of transformers may include typical load profiles, ambient temperature variations, environmental issues such as pollution, lightening, number of switching operations, behaviour of similar units, number of faults per location, condition of the accessories, time in operation and the like. Further laboratory inspection data may include DGA, insulation tests, visual inspection, standard oil test, bushing test and the like. In addition to the operational data and laboratory data, site electrical measurement data such as insulation power factor, visual inspection, insulation test, bushing tests and the like, may also be stored in the HVE data 110. The historical failure data may include data for both internal faults and external faults. For example, data related to insulation failure may be an internal failure data, where the problem may be associated with internal or external winding insulation, or a flashover that may occur along the winding of the transformer. In a second example, data related to transformer lead to ground failure may be an external failure data, where the problem may be associated with voltage breakdowns, or when the measured current does not show a remarkable increase or if it even drops in comparison to the reference current and the like indicating that the current path was through ground. Thus, the data obtained from the plurality of HVEs 106 may be used to identify a fault condition/cause for an HVE.

The HVE data 110 may further include on-line system monitoring data or online monitoring data of transformers. In one example, the online parameters may be measured through sensors which may be connected to online monitoring systems. Some of the online monitoring data points include secondary rated root mean square (RMS) and phase voltages, secondary rated RMS and phase currents, average winding temperatures, hydrogen content in oil, top oil temperature of the transformers, average oil temperature, tank pressure, oil humidity and the like. These parameters may be continually updated in the HVE data 110 on receipt from the plurality of HVEs 106.

Further, the system 100 may include a plurality of models 112 that may be generated, trained and tuned using the HVE data 110. The plurality of models 112 may include models and sub-models categorized/functioning according to their specific purpose. For example, there can be one or more models/sub-models used as data reduction models, simulation and forecasting models, failure signature models, and prognostic models. The data reduction models may be specific to each event, such as thermal based events, dielectric, high voltage based, low voltage based, current and voltage-based events, and may be used to simplify the input data provided to the other models. Simulation and forecasting models may be used to simulate the operating/application based conditions and forecast the performance parameters based on the present and the past data and be able to predict failure and provide prognosis using the failure signature models and the prognosis models. The failure signature models may include one or more models for predicting failure mode due to various internal or external causes from monitored data. The failure mode may include, for example, partial discharge-based failure, switching failure, insulation failure, short circuit failure, earth fault failure, and the like. The prognosis models may be used for lifetime prediction, failure event prediction, failure event scheduling, and rule-based prognosis response recommendation (prognostic response). There can be other models that based on prognosis provide a response (prognostic response) for service, maintenance or feedbacks for design and performance improvements with recommendations of new benchmark values to be used in testing. Depending on the user requirements, i.e. what kind of outcomes are desired, one or more models can be selected (dynamically selected according to the user requirements or configuration made in the system according to the user requirement).

The plurality of models 112 may be machine learning models, stochastic models, or empirical models and may be periodically updated, trained, and tuned based on the HVE data 110. Tuning of the plurality of models 112 refers to generation of model parameters specific to particular types, performance, or/and behaviour (response to a condition/event) of HVEs. A type of an HVE may refer to the specification, such as electrical rating of the HVE, and the industry in which it is deployed.

The system 100 may access the HVE data 110 for generation and tuning of the plurality of models 112. In addition, for a particular HVE for which prognosis is to be performed, such as an installed HVE 114, the system 100 may also receive various input parameters 116 from the installed HVE 114 and the databases 108. It will be understood that the installed HVE 114 is also part of the plurality of HVEs 106 and is depicted separately only for ease of discussion.

To perform prognosis for the installed HVE 114, the system 100 may dynamically select one or more models from the plurality of models 112 tuned from HVE data 110 obtained from the plurality of HVEs 106 communicatively connected with the system 100. The dynamic selection of the one or more models may be based on a periodic evaluation of the plurality of the models with one or more performance criteria for evaluation or/and based on the desired service (outcome) determined as per user requirements. For example, the performance criteria may include model fidelity and at least one of parameters representing time taken for computation, and resources consumed for computation. The resources consumed may include one or more of memory, input data size, and number of input parameters required for the model. Also, the desired service can be one or more of alert services, maintenance services, reports, recommendations for controlling/maintaining operation of HVE etc., and the user requirements can be related to cost, time for service and complexities involved in performing any activity along with its efficacy. The prognostic response accordingly will be based on (configured according to) the performance criteria and/or service/user requirements. The model (sub-model) used to generate a prognostic response is generally referred herein as a prognostic model.

In one example, the selected one or more models may comprise a first plurality of models corresponding to failure signature models for predicting the failure mode and may be generated from historical failure data obtained from similar type of HVEs from the plurality of HVE 106 as the installed HVE 114. Further, the selected one or more models may comprise a second plurality of models corresponding to prognostics models for generating the at least one prognostic response from historical behaviour data of similar type of HVEs from the plurality of HVEs 106 as the installed HVE 114 and user requirement specification.

The system 100 may then predict a failure mode of the installed HVE 114 based on the input parameters 116 associated with the installed HVE 114 using the selected one or more models. The system 100 may also determine at least one prognostic response 118 for the installed HVE 114 based on the predicted failure mode using the selected one or more models. Further, the at least one prognostic response 118 may be provided for the installed HVE 114, for example, for scheduling maintenance.

In one example, determination of the prognostic response 118 includes predicting a failure event based on the failure mode prediction and a prognosis of the installed HVE 114 determined from the one or more models. Further, a schedule of the failure event may be predicted and the at least one prognostic response 118 may be determined based on the schedule and predefined rules.

In one example, the determination of the prognostic response 118 is also based on at least one user requirement 120 associated with a maintenance service of the installed HVE 114. For example, a user may specify in the user requirement 120 that maintenance may be performed at the earliest after five months. In such a case, the prognostic response 118 will recommend the operating conditions to be used so that the HVE 114 may be reliably operated for at least five months without maintenance.

FIG. 1b illustrates an example monitoring system in which prognosis of an installed HVE may be performed based on data received from databases, in accordance with an example implementation of the present subject matter.

In one example, the databases 108 may include a plurality of databases, such as a first, second, and third database DB 122-2, 122-2, and 122-3. The first database DB 122-1 can include name plate data, factory operational data, factory test data, and HVE performance data. The second database DB 122-2 can include field historical operational data, field failure data, and field measurement data. The third database DB 122-3 can include online HVE monitoring data and online system monitoring data.

In one example, the system 100 may include two sub systems, sub system 124-1 and sub system 124-2. The sub system 124-1 may implement models such as prognostics models, machine learning models, and failure signature models. The sub system 124-2 may implement models, such as failure event predictor, failure event scheduler, and prognostic based action selector. The prognostic based action selector may determine and provide the prognostic response based on pre-defined action events stored as rules in the sub system 124-2.

The working of the sub systems to determine the prognostic response will be explained with reference to an example. It will however be understood that the discussed example and the illustration shown in FIG. 1b is non-limiting and various other implementations will also be evident to the person skilled in the art based on the teachings of the present disclosure and are intended to be covered within the scope of the appended claims.

In one example scenario, it may be observed that the installed HVE 114 performs below expectations due to an issue that has occurred. For the sake of this example, let the installed HVE 114 be a three-phase transformer. The HVE data 110 of the installed HVE 114 stored in the database 108 is constantly updated and based on these values it may be observed that there is a rise in temperature of phase 2. Also, the voltages at all the three phases of the transformer is the same but the value of current in phase 2 and phase 3 is gradually increasing. Based on this trend, the sub system 124-1 may be able to analyze the various failures that may be associated with the transformer. For example, sub system 124-1 may provide data that indicates an unbalanced load condition in the transformer as the load on phase 2 and phase 3 is increasing. Phase 2 may be placed in a critical position between phase-1 and phase-3 due to which heat dissipation may be affected. This analysis that is computed by sub system 124-1 is further provided to sub system 124-2.

The sub system 124-2 receives analyzed data from the sub system 124-1, based on which the models of sub system 124-2 may predict the timeline for the occurrence of failure and determine a schedule for the failure event based on the criticality. Further, the sub system 124-2 processes the data to provide an action plan. The action plan may include various steps that could be taken to avoid the failure, such as reduction in the load on phase 2, rearrangement of the load of the transformer to balance the load, and the like. Apart from this, it may also provide a detailed response based on the event scheduling and criticality. For example, it may suggest that if the same trend continues for a period of three months then, based on the present condition of deterioration of insulation which may worsen, there may be insulation failure in three months. It may also provide a life cycle calculation which is an online calculation based on the standards and the current position of the transformer indicating the reduction in the life cycle at present due to the temperature rise, if the same trend continues what would be the life cycle of the transformer, the life time expectancy and the like. Accordingly, it may determine an action to be taken based on the predefined action or rules for the event.

This information from sub system 124-2 may be provided as the prognostics response 118. The prognostics response 118 may be in the form of a graph. The graph may depict the trend of an increase in temperature, loading conditions of the three phases, the time at which the transformer may fail, action to be taken, and the like.

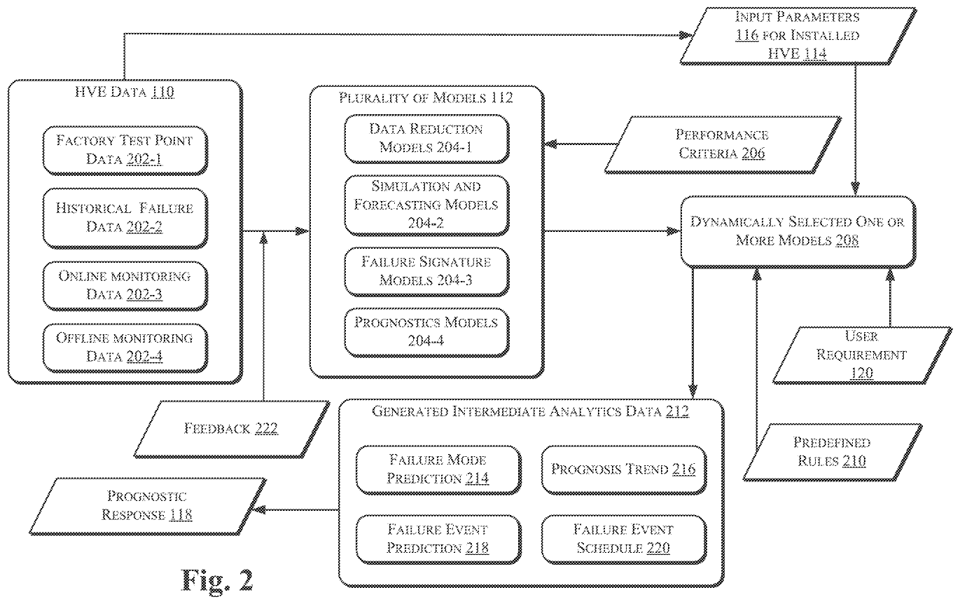

FIG. 2 is a schematic illustration of prognosis of an installed HVE performed by the system, in accordance with an example implementation of the present subject matter.

As discussed, the HVE data 110 may be collected for a plurality of HVEs 106, including the installed HVE 114 and stored in databases 108. The HVE data 110 includes factory test point data 202-1, historical operational and failure data 202-2, online monitoring data 202-3, and offline monitoring data 202-4.

The factory test point data 202-1 includes nameplate data and test data points captured from manufactured and tested transformers. The test data points include data points from routine tests, type tests, and special tests. Nameplate data includes kVA rating, voltage ratio, insulation class, presence of on-load tap changer (OLTC), number of phases, etc. The routine tests for which data points may be captured include no load loss test, magnetic current measurement—excitation current, load loss measurement, voltage ratio, winding resistance, insulation dissipation factor, capacitance and insulation resistance, insulation resistance test, power factor test, etc. The special tests for which data points may be captured include sound level, dissolved gas analysis, zero-sequence impedance, partial discharge test, and the like. The type tests for which data points may be captured include temperature rise test, short circuit test, lightening impulse test, and the like.

The historical failure data 202-2 relates to various failures that may have occurred in the past. These can include failures due to internal causes and external causes. The internal causes of failure may be, for example, insulation failure, transformer winding disk to disk failure, transformer winding turn to turn failure, winding shield & cable failure, short circuit failure, partial discharge failure, switching failure, impulse failure inside the tank, etc. The external causes of failure may be transformer to ground failure, transformer lead to ground failure, bushing failure, impulse failure outside the tank, etc.

The online monitoring data 202-3 include the parameters measured through sensors that are attached to online monitoring and control system, such as SCADA system. Some of these parameters are secondary rated RMS and phase voltages, secondary rated RMS and phase currents, average winding temperatures, hydrogen content in oil (in ppm), top oil temperature, average oil temperature, tank pressure, oil humidity, and the like.

The offline monitoring data 202-4 includes offline collected operational data such as site operation data, laboratory inspection data, site electrical measurement data, and failure data for analysis and diagnosis of various internal and external causes of failure. The site operation data includes typical load profile, ambient temperature variation, environmental issues (like pollution, lightning, etc.), number of switching, voltage transient data, current transient data, behavior of similar units (statistical database), number of through faults per location, how well the accessories are kept, have accessories been replaced during operation, lightning strikes based on places, is it near geographic information system (GIS), time in operation, and the like. The laboratory inspection data includes data from dissolved gas analysis (DGA) test, insulation test, standard oil test, bushing test, etc. the site electrical measurement includes data related to insulation power factor, visual inspection, insulation test, bushing tests, etc. It may also include field data. For example, it may include data regarding when the HVE was stored in the field and when the HVE started operating in the field. In scenarios where the HVE may be stored in the field for a period of six months to a year, the field data in relation to the HVE stored may include the environmental conditions, the mechanism of storage, the location of storage, if stored away from the field and the type of transportation that was done, loading and unloading conditions and the like.

The HVE data 110 may be used to generate and tune the plurality of models 112. The plurality of models 112 may include data reduction models 204-1, simulation and forecasting models 204-2, failure signature models 204-3, and prognostics models 204-4. Each of these models may be implemented as machine learning models, stochastic models, or empirical models, such as regression models. Further, the models may be periodically tuned (updated by continuous trained learning) using the HVE data 110 or in the case of machine learning models, the system 100 may learn and update the models as HVE data 110 is collected. The initial tuning (adaptation) of the models are done with training data (a part of the collected HVE data).

The data reduction models 204-1 help to process the raw input parameters to simplify and reduce the data that is to be further processed by the other models, for example, the simulation and forecasting models 204-2. In one example, the data reduction models 204-1 may be machine learning models. A plurality of machine learning models may be created based on the type of data or predefined events for an HVE. For example, there may be thermal machine learning model, partial discharge machine learning model, high voltage machine learning model and the like. These models may employ a plurality of algorithms to process raw input parameters from the constantly updated database 108 and reduce the data to be processed further. For example, if there are 5 transformers with the same specification of 2000 kVA, each of those transformers may have different temperature rise values and the thermal output of these 5 transformers may be different. In scenarios where the thermal output may be required for analyzing a fault trend, the thermal based machine learning model may be configured to give one thermal output value based on the data it receives from these five transformers. Thereby, reducing the variability in the data that may be provided to the other models for analysis.

The simulation and forecasting models 204-2 help to simulate the operation of the installed HVE 114 and forecast the future performance parameters of the installed HVE 114. For example, if values for tested loss, no load temperature, load temperature, partial discharge current are available for 1000 kVA transformer with distribution application, having impedance of 5%, it can be used to determine parameters for 1250 kVA transformer having impedance of 5.8%. This allows the system to perform prognosis for HVEs even if data is not available in the HVE data 110. In another example, if 20% overloading of the transformer with F class insulation is found to increase the average temperature of winding by 7 Degree C., this information will train model for similar specified transformer range. The simulation and forecasting models 204-2 are used by the failure signature models 204-3 and prognostic models 204-4 for failure mode prediction and providing the at least one prognostic response 118.

The failure signature models 204-3 use the failure data and create fault signature trees. The output of these models will be the failure trend and logical signatures and failure mode predictions. For example, if the excitation current on one of the phases is going beyond 30% of rated no load current, it will determine that the transformer is likely to go into an unbalanced condition. In another example, if the voltage harmonics on secondary of the transformer is higher than the tested data value points by 10%, it will determine that this can lead to increase in average winding temperature by approximately of 6˜8 degree C. and possible failure. Accordingly, fault signatures may be obtained for different failures, such as partial discharge based failure, switching or impulse failure, insulation failure, short circuit failure, earth fault failure, and the like. Thus, the failure signature models 204-3 can provide as output the probability of different types of failure at different points in time in the future.

The prognostics models 204-4 help to determine the prognosis trends including remaining life and behavior of the installed HVE 114. Further, based on the predicted failure mode and the prognosis trends, the prognostics models 204-4 can predict failure events, schedule failure events, and provide the prognostic response as will be discussed below. In one example the system 100 may dynamically select a prognostic model based on the failure trend to provide the prognostics response.

The plurality of models 112 may be tuned based on the HVE data 110 for different industries, geographic locations, etc. For example, different sets of models may be used in case the installed HVE 114 is employed in metro rail transport or in oil and gas industry.

In one example, one or more models 208 are dynamically selected from the plurality of models 112 based on performance criteria 206. The performance criteria 206 may be user defined or predefined and stored in the system 100 as a configuration for setting up analysis using the one or more models. As there may be several different models that can provide different outputs (outcomes) and can have different input data requirement, resource requirement, such as processor and memory requirements, etc., the performance of the different models may vary. The performance of the models may be monitored with help of various performance metrics related to the performance criteria. The performance criteria 206 include accuracy/fidelity of the model to predict failure and recommend a suitable prognostic response. Other performance criteria include complexity of the model, which may affect time taken for computation and resource requirement, accuracy of time or cost estimation for the recommended prognostic response, size and type of input data used, and the like. The performance of the plurality of models 112 may be updated based on feedback 222 including usefulness of recommendation, cost, time, effort information about the actual action taken, improvement seen from online measurement or recent history after the prognostic response is performed, and the like. Over time, one or more models may evolve for its use as a preferred prognostic model for a specific failure mode or/and for a component of HVE based on data collected from plurality of HVE 106, use of the models and received feedback 222.

Upon selection of the one or more models 208 dynamically, the system may use the selected one or more models 208 to determine the prognostic response 118 for the installed HVE 114 based on the input parameters 116 corresponding to the installed HVE 114. The input parameters 116 may be received from the HVE data 110 and directly from control systems connected to the installed HVE 114, as discussed earlier. The system 100 may also consider the user requirement 120 and predefined rules 210 to select one or more models and generate the prognostic response 118.

In one example, the system 100 may generate various intermediate analytics data 212 based on the one or more models 208 prior to generation of the prognostics response 118. As discussed earlier, the dynamically selected one or more models 208 may also include subsets of the data reduction models 204-1, simulation and forecasting models 204-2, failure signature models 204-3, and prognostics models 204-4 based on different principles/techniques (e.g. machine learning, stochastic models, empirical models etc.) and can be parallelly used for analysis and continuous tuning/evolution of the various models. One or more models are selected based on their performance and suitability for the installed HVE 114 and user specification. In one example, the system 100 may first predict a failure mode 214 based on the input parameters 116 (refined by the data reduction models 204-1) and failure signature models 204-3. The predicted failure mode 214 provides probabilities of occurrence of different failure types. The predicted failure mode 214 and the input parameters 116 may be then used by prognostics models 204-4 to determine prognosis trends 216. The prognosis trends 216 indicate how the behavior of the installed HVE 114 is likely to evolve over time. Further, based on the predicted failure mode 214 and the prognosis trend 216, a failure event 218 may be predicted and a failure event schedule 220 may be generated by the prognostics models 204-4. Further, the prognostics models 204-4 may apply the user requirements 120 and the predefined rules 210 for determining the prognostics response 118. For example, based on the predefined rules, the system 100 may recommend servicing after three months. However, the user requirement may specify that a servicing may be performed only after five months. In such a case, the system 100 may select a suitable specific model to meet this requirement (according to predefined configurations) and determine the prognostics response 118 that may recommend suitable operating conditions for operating the installed HVE for the next five months (learnings from observations/events/responses made from plurality of HVEs) and fulfill the user requirement of servicing after five months.

Thus, the present subject matter provides for better prognosis of HVEs in an efficient and flexible manner and provides for a means to gather user requirements/response including feedbacks through a suitable interface of the monitoring system and consider them in assessment of the associated installed HVE with dynamically selected models according to the performance and/or user specification. The prognostic response can be made use by a user of the installed HVE, manufacturer of the installed HVE, design, quality or test teams related to the installed HVE or by a service person associated with the installed HVE, and the system can be configured to provide the response to all such persons according to the event communication/alert configuration made in the system.

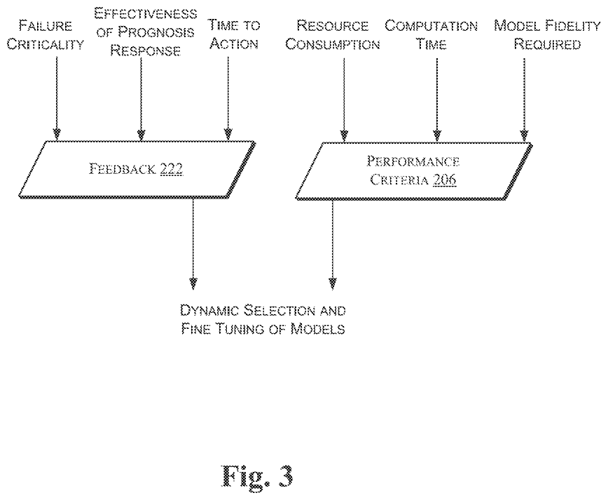

FIG. 3 is a schematic illustration of an example use case for dynamic selection of one or more models, in accordance with an example implementation of the present subject matter.

In one example, various parameters may be provided as performance criteria 206 and feedback 222 (collectively referred for user related specifications/feedbacks) for the dynamic selection and fine tuning of the one or more models including the machine learning models. In one example, feedback 222 may be severity/criticality of a fault observed in the installed HVE 114. The criticality of fault information (failure related data along with its probability of occurrence, criticality etc.) can also be made available in the monitoring system and made use by one or more models to determine failure modes and/or prognostic response, and the one or more models can be finetuned based on the feedback received from the user. The system can provide for a suitable interface to capture user requirements including priority/important performance criteria or/and constraints/outcomes (e.g. scheduled maintenance after 5 months), and use these as a configuration to dynamically select models for monitoring/assessment of the installed HVE according to the performance criteria provided by the user or as per recommendations made by the system as a best practice for selection of the model.

In one example, performance criteria 206 may include model fidelity or accuracy of the model to predict the performance of the installed HVE 114. The model fidelity may depend on accuracy of predicted performance for a specification in comparison to observed/assessed performance of the installed HVE 114.

For example, if there is an increase in temperature, the models may check if the temperature rise has an effect on the losses as well. Further, in one example, it may analyze that apart from internal temperature rise, there is an increase in the external temperature rise as well and it may be related to the accessories and surrounding components. In another example, it may also analyze based on the time at which an increase in temperature is observed. The prediction and the observations (user based or through online/offline parameters) can be compared to determine fidelity of the utilized models from the plurality of the models available with the system. Thus, the model fidelity functions as one of the performance criteria and may be used for dynamic selection of the models from the one or more models available with the monitoring system.

In addition, the resources consumed for computation and the time required for computation of the prognosis response may be used as performance criteria 206 for dynamic selection of one or more models from the plurality of the models. The resources consumed, and the time required may be related to the model complexity. For example, one of the models may use a particular technique, such as regression, and a particular number of coefficients, such as three coefficients, to predict a particular outcome. In another example, another one of the models may use a different technique or a different number of coefficients to predict a particular outcome. The system 100 may select a model implementing a particular technique or a model with a particular number of coefficients based on parameters such as, fault evolution or the time required by the algorithm to predict an outcome and the like.

In one example, the performance criteria may also consider user requirements 120. For example, a user may want to load the transformer at 120% due to an increase in demand. The user, being aware that the transformer is deteriorating, may want to know for how long the transformer can run on 120 percent loading and after how long should the loading be reduced. Based on the dynamic requirement variables from the user, dynamic selection of the algorithms can take place to provide a prognostic response.

In one example, feedback 222 may include failure criticality, effectiveness of prognosis response, and time to action. The failure criticality may indicate how critical the fault or failure would be to the business based on factors, such as cost of unscheduled repairs, cost of lost or incomplete output of the installed HVE 114, cost of incurred damages, etc. The time to action indicates the time required for the repair/maintenance to be performed and considers logistics efficiency, etc. The effectiveness of the prognosis response may consider how successful the prognosis response provided by the different models has been in previous scenarios so that the most effective model may be selected.

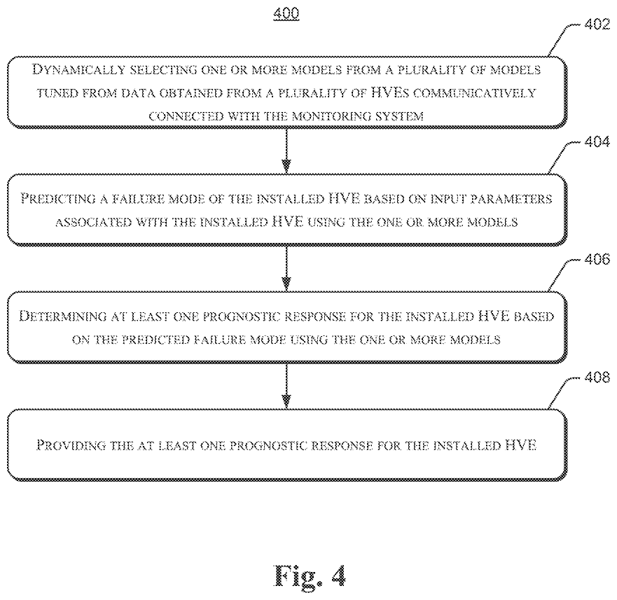

FIG. 4 illustrates an example method 400 for prognosis of an installed HVE by a monitoring system, in accordance with an example implementation of the present subject matter. The order in which the method 400 is described is not intended to be construed as a limitation, and any number of the described method blocks may be combined in any order to implement the method 400, or alternative methods. Furthermore, the method 400 may be implemented by processing resource(s) or computing device(s) through any suitable hardware, non-transitory machine-readable instructions, or a combination thereof.

It may be understood that blocks of the method 400 may be performed by programmed computing devices and may be executed based on instructions stored in a non-transitory computer readable medium, such as the memory 104. The non-transitory computer readable medium may include, for example, digital memories, magnetic storage media, such as magnetic disks and magnetic tapes, hard drives, or optically readable digital data storage media. Although the method 400 may be implemented in a variety of systems, the method 400 is described in relation to the system 100, for ease of explanation.

At block 402, one or more models are dynamically selected from a plurality of models tuned from data obtained from a plurality of HVEs. In one example, the dynamic selection of the one or more models is based on a periodic evaluation of the plurality of the models with one or more performance criteria for evaluation. The performance criteria include, for example, model fidelity and at least one of parameters representing time taken for computation, and resource consumed for computation. The resources consumed may include one or more of memory, input data size, and number of input parameters required for the model. The one or more models correspond to at least one of a machine learning model, a stochastic model, or an empirical model.

At block 404, a failure mode of the installed HVE is predicted based on input parameters associated with the installed HVE using the one or more models. The input parameters include at least one of online monitoring data relating to the performance of the installed HVE, offline operational data of the installed HVE, and factory data of the installed HVE. In one example, the one or more models include models for simulating and forecasting performance data of the installed HVE. Further, the one or more models comprise a first plurality of models corresponding to failure signature models for predicting the failure mode generated from historical failure data obtained from similar type of HVEs from the plurality of HVE as the installed HVE. The first plurality of models comprises models for one or more of partial discharge based failure, impulse failure, insulation failure, short circuit failure, earth fault failure and the like.

At block 406, at least one prognostic response is determined for the installed HVE based on the predicted failure mode using the one or more models. For example, the one or more models comprise a second plurality of models corresponding to prognostics models for generating the at least one prognostic response from historical behavior data of similar type of HVEs from the plurality of HVEs as the installed HVE and user requirement specification. The determination of the prognostic response may include predicting a failure event based on the failure mode prediction and a prognosis of the installed HVE determined from the one or more models. Further, a schedule of the failure event may be predicted and the at least one prognostic response may be determined based on the schedule and predefined rules. In one example, at least one user requirement associated with a maintenance service of the installed HVE is also considered while determining the at least one prognostic response.

At block 408, the at least one prognostic response is provided for the installed HVE. For example, the at least one prognostic response may be provided to an operator or third party for performing servicing or maintenance of the installed HVE.

Although examples for the present subject matter have been described in language specific to structural features and/or methods, it should be understood that the appended claims are not limited to the specific features or methods described. Rather, the specific features and methods are disclosed and explained as examples of the present subject matter.

1. A method for prognosis of an installed high voltage equipment (HVE) by a monitoring system, the method comprising:
dynamically selecting one or more models from a plurality of models tuned from data obtained from a plurality of HVEs communicatively connected with the monitoring system;
predicting a failure mode of the installed HVE, based on input parameters associated with the installed HVE, using the one or more models;
determining at least one prognostic response for the installed HVE, based on the predicted failure mode, using the one or more models; and
providing at least one prognostic response for the installed HVE.

2. The method of claim 1, wherein the dynamic selection of the one or more models is based on a periodic evaluation of the plurality of the models with one or more performance criteria for evaluation.

3. The method of claim 2, wherein the performance criteria comprise model fidelity and at least one of parameters representing time taken for computation, and resource consumed for computation.

4. The method of claim 3, wherein the resources consumed comprise one or more of memory, input data size, and number of input parameters required for the model.

5. The method of claim 1, wherein the input parameters comprise at least one of online monitoring data relating to performance parameters of the installed HVE, offline operational data of the installed HVE, and factory data of the installed HVE.

6. The method of claim 1, comprising simulating and forecasting performance data of the installed HVE based on the one or more models.

7. The method of claim 1, wherein the one or more models correspond to at least one of a machine learning model, a stochastic model, or an empirical model.

8. The method of claim 1, wherein the one or more models comprise a first plurality of models corresponding to failure signature models for predicting the failure mode generated from historical failure data obtained from similar type of HVEs from the plurality of HVE as the installed HVE.

9. The method of claim 1, wherein the first plurality of models comprises models for one or more of partial discharge based failure, impulse failure, insulation failure, short circuit failure, and earth fault failure.

10. The method of claim 1, wherein the one or more models comprise a second plurality of models corresponding to prognostics models for generating the at least one prognostic response based on historical behavior data of similar type of HVEs from the plurality of HVEs as the installed HVE and user requirement specification.

11. The method of claim 1, wherein determining the at least one prognostic response comprises:
predicting a failure event based on the failure mode prediction and a prognosis of the installed HVE determined from the one or more models;
predicting a schedule of the failure event; and
determining the at least one prognostic response based on the schedule and predefined rules.

12. The method of claim 11, wherein the determining the at least one prognostic response is further based on at least one user requirement associated with servicing of the installed HVE.

13. A monitoring system for prognosis of an installed high voltage equipment (HVE), the system comprising a processor configured to execute instructions to:
dynamically select one or more models from a plurality of models tuned from data obtained from a plurality of HVEs communicatively connected with the monitoring system;
predict a failure mode of the installed HVE, based on input parameters associated with the installed HVE, using the one or more models;
determine at least one prognostic response for the installed HVE, based on the predicted failure mode, using the one or more models; and
provide the at least one prognostic response for the installed HVE.

14. The system of claim 13, wherein the dynamic selection of the one or more models is based on a periodic evaluation of the plurality of the models with one or more performance criteria for evaluation, wherein the performance criteria comprise model fidelity and at least one of parameters representing time taken for computation, and resource consumed for computation.

15. The system of claim 13, wherein the input parameters comprise at least one of online monitoring data relating to performance parameters of the installed HVE, offline operational data of the installed HVE, and factory data of the installed HVE.

16. The system of claim 13, wherein the processor is to simulate and forecast performance data of the installed HVE based on the one or more models.

17. The system of claim 13, wherein the one or more models comprise:
a first plurality of models corresponding to failure signature models for predicting the failure mode generated from historical failure data obtained from similar type of HVEs from the plurality of HVE as the installed HVE, and wherein the first plurality of models comprises models for one or more of partial discharge based failure, impulse failure, insulation failure, short circuit failure, and earth fault failure; and
a second plurality of models corresponding to prognostics models for generating the at least one prognostic response from historical behavior data of similar type of HVEs from the plurality of HVEs as the installed HVE and user requirement specification.

18. The system of claim 13, wherein to determine the at least one prognostic response, the processor is to:
predict a failure event based on the failure mode prediction and a prognosis of the installed HVE determined from the one or more models;
predict a schedule of the failure event; and
determine the at least one prognostic response based on the schedule and predefined rules.

19. The system of claim 13, wherein the determining the at least one prognostic response is further based on at least one user requirement associated with servicing of the installed HVE.

20. A non-transitory computer-readable medium comprising instructions that, when executed by a processor, cause the processor to:
dynamically select one or more models from a plurality of models tuned from data obtained from a plurality of HVEs communicatively connected with the monitoring system, wherein the dynamic selection of the one or more models is based on a periodic evaluation of the plurality of the models with one or more performance criteria for evaluation;
predict a failure mode of the installed HVE, based on input parameters associated with the installed HVE, using the one or more models;
determine at least one prognostic response for the installed HVE, based on the predicted failure model, using the one or more models, wherein to determine the at least one prognostic response, the processor is to:
predict a failure event based on the failure mode prediction and a prognosis of the installed HVE determined from the one or more models;
predict a schedule of the failure event; and
determine the at least one prognostic response based on the schedule and predefined rules; and
provide the at least one prognostic response for the installed HVE.
